(19) United States
(12) Patent Application Publication
(10) Pub. No.: US 2008/0053548 A1
(43) Pub. Date: Mar. 6, 2008

(54) PLASTIC TUBING INSTALLATION ORGANIZATION SYSTEM

(75) Inventor: Michael K. Ellery, West Warwick, RI (US)

Correspondence Address: BARLOW, JOSEPHS & HOLMES, LTD., 101 DYER STREET, 5TH FLOOR, PROVIDENCE, RI, 02903, US

(73) Assignee: CRAMIK ENTERPRISES, INC., Westerly, RI (US)

(21) Appl. No.: 11/850,132

(22) Filed: Sep. 5, 2007

Related U.S. Application Data
(60) Provisional application No. 60/824,491, filed on Sep. 5, 2006.

(51) Int. Cl. F16L 55/00

(52) U.S. Cl. 138/104; 138/96 R; 138/89

(57) ABSTRACT

A plastic tubing organization system is provided that facilitates easy identification of the terminal ends of the tubing while also including an end cap that protects the pipe from contamination and facilitates installation thereof. The system generally includes an indexing card with a plurality of receiver positions therein and a plurality of end caps removably received within the receiver positions on the indexing card. Further, the end caps are coded to match the receiver positions thereby allowing easy correlation between the tubing bearing the end cap and the receiver position on the indexing card.

### CROSS-REFERENCE TO RELATED APPLICATIONS

This application is related to and claims priority from earlier filed U.S. Provisional Patent Application No. 60/824,491, filed Sep. 5, 2006.

### BACKGROUND OF THE INVENTION

The present invention relates to a system for organizing and facilitating the installation of a tubing system. More specifically, the present invention relates to a system for tagging and identifying a plurality of pipes during installation in a manner that makes their installation and final organization easier.

Over time, energy costs have generally experienced an upwardly spiraling trend that has no end in sight. These dramatically increasing costs make the efficient supply of environmental heat to a building a major concern for many, including building owners, designers and managers. One industry solution that has been developed to facilitate the effective and efficient delivery of environmental heat to a building is the use of radiant heating systems. Radiant heating systems work on the principal of heating the building structure itself in a manner that causes the building structure to in turn radiate heat into the spaces within the building. Radiant heating systems typically work by employing a pipe network that is installed within the structure or underneath a building's floor. Heated water circulates through the pipes, evenly warming the floor. The heated floor in turn radiates heat to the occupied space. Because the heating element in the room is the mass of floor and objects on the floor, areas closer to the floor will be warmer than those near the ceiling. As a result of heating all of the mass in the lower areas of the room where the occupants are, the occupants are generally more comfortable at lower thermostat settings as compared to other heating systems that allow heated air to amass in the farthest heights of the room. Furthermore, the large surface area of the floor ensures horizontal heat uniformity across the entire area of the room.

As was stated above, such radiant heating systems rely on a large and complex pipe network to heat a floor. This network is usually installed in a manner wherein a flexible water pipe for carrying a heated water supply covers a substantial portion of the floor's underside. Further, this tubing network must be connected to a supply line and a return line that must in turn be fed back to a manifold and control system that ultimately attaches to the heated water supply. Accordingly, such systems are typically installed using a plurality of runs of relatively small diameter flexible plastic tubing.

In this regard, it is well known that in recent years polymeric pipe and tubing materials have displaced conventional steel pipe and copper tubing in such heating applications. Further, they are also becoming the accepted standard for installing both domestic hot and cold water supply systems. Tubing that is utilized in these applications include polymeric materials, such as ethylene propylene diamine (EPDM) rubber, polyvinyl chloride (PVC) and polyethylene (PE). More recently, cross-linked polyethylene (PEX) has become the growing standard for use in home construction for heating systems and the installation of potable water supply lines inside walls, replacing the use of other metal or plastic materials. PEX tubing is also being used for riser tubes, without attached end fittings.

When installing such systems, continuous runs of tubing that loop out and back around a building's structure need to be installed. Further, these pipes must be installed through a plurality of holes drilled in the structure between the desired service location and the point of origin for the heating system or water service. During the installation process all of the looped tubing runs are first installed with their ends left hanging at a termination location where they are later attached to the correct system component, be it a zone manifold for a heating system, the cold water supply or the hot water supply. Accordingly, when it is time to connect all of the loose ends of the tubing, it is important to be able to identify each discrete piece of tubing in order to insure that they are correctly connected. For example, it would be disastrous if a domestic cold water line were accidentally connected to a heating zone.

In order to identify tubing lines in the prior art, installers typically wrote on the sidewall of the tubing with a marker. Frequently, the installers would write a code such as a letter or number that corresponded to each tubing run and then keep a log on a scrap of paper of cardboard that identified the code. For example, A may be heating zone 1 supply, B may be heating zone 1 return, C may be domestic cold water 1^{st} floor bathroom, etc. The difficulty is that should the scrap of paper be lost the codes on the tangle of tubing at the terminal end would be undecipherable. Similarly, it is possible that as the tubing is drawn through the walls of the building or if the tubing gets wet, as is often the case in a building that is under constructing, the code becomes obscured or is completely lost. Further, once the tubing is pulled to the end location, the tail of the tubing bearing the code may be cut at a point where the code is no longer affixed to the original length of tubing.

Another difficulty is that as the tubing is threaded through the structure, the open end of the tubing walls gets caught on the edges of various items it contacts, such as plywood sub-flooring or dimensional lumber framing members. Further, in addition to getting caught on the building material, it is possible that a large amount of dirt, debris, sawdust or other contaminants may enter the open end of the tubing as it is threaded through the walls and floors of the building.

Accordingly, there is a need for a system that provides for easy identification and organization of tubing as it is installed into a structure. Further, there is a need for a system that facilitates organization of tubing in a reliable manner that also aids in the installation of the tubing by capping the leading end of the tubing as it is installed into the structure.

### BRIEF SUMMARY OF THE INVENTION

In this regard, the present invention provides a plastic tubing organization system that facilitates easy identification of the terminal ends of the tubing while also including an end cap that protects the pipe from contamination and facilitates installation thereof. The system generally includes an indexing card with a plurality of receiver positions therein and a plurality of end caps removably received within the receiver positions on the indexing card.

The indexing card has a plurality of receiver positions thereon in the form of holes that extend either fully or partially therethrough. The receiver positions are sized and shaped to receive and retain a plurality of end caps as will be described in further detail below. The indexing card also includes an identifier tag adjacent each receiver position such that the identifier tags on the indexing card correspond to an identical tag on the end cap that is received in the receiver position. For example, if the identifier tags are numbers, 1, 2, 3, . . . then each of the end caps will include corresponding numbers thereon. Similarly, if the identifier tags are colors, red, blue, green, . . . then each of the end caps will include the corresponding color thereon. Finally, the indexing card preferably includes a space adjacent the identifying tag that allows the user to write relevant information corresponding to that particular receiver position in order to identify the tubing at a later date.

The end caps are formed to have a head portion and a tail portion. The head portion is preferably tapered or rounded in a manner that allows it to be easily threaded through a building structure as the tubing is installed. The tail portion is formed to be inserted and frictionally retained in the leading open end of the tubing. The end cap, once installed into the tubing, serves to identify the tubing while also plugging the tubing to prevent entry of contaminants and preventing the end of the tubing from being damaged during installation. When not in use, the end caps are installed back into the corresponding receiver locations on the indexing card.

In operation, a user selects an end cap and removes it from the receiver location on the indexing card. The end cap is then installed into the leading end of the tubing to be installed. A notation is made in the correct location on the indexing card relative to the tubing run that is being installed, i.e. domestic cold-water 1^{st} floor bath. The tubing is then installed by fishing it through the building structure. The above process is then repeated for each of the tubing runs that need to be installed. Once the tubing is all installed, the user simply returns to the location where the terminal ends of the tubing are installed and identifies each piece of tubing by the end cap installed therein, removes the end caps as the terminal ends of the tubing are attached to the correct utility and then returns the end caps to the receiver position on the indexing card.

It is therefore an object of the present invention to provide a system that allows for easy identification and organization of tubing as it is installed into a structure. Further, it is an object of the present invention to provide a system that facilitates organization of tubing in a reliable manner that also aids in the installation of the tubing by capping the leading end of the tubing as it is installed into the structure. It is still a further object of the present invention to provide a method for the organization of tubing in a reliable manner that also aids in the installation of the tubing by capping the leading end of the tubing as it is installed into the structure

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of a tubing organization system in accordance with a first embodiment of the present invention;

FIG. 2 is a cross-sectional view taken along line 2-2 of FIG. 1;

FIG. 3 is a front perspective view of a tubing organization system in accordance with a second embodiment of the present invention;

FIG. 4 is a cross-sectional view taken along line 4-4 of FIG. 3; and

FIG. 5 is a front perspective view of a tubing organization system in accordance with a third embodiment of the present invention.

### DETAILED DESCRIPTION OF THE INVENTION

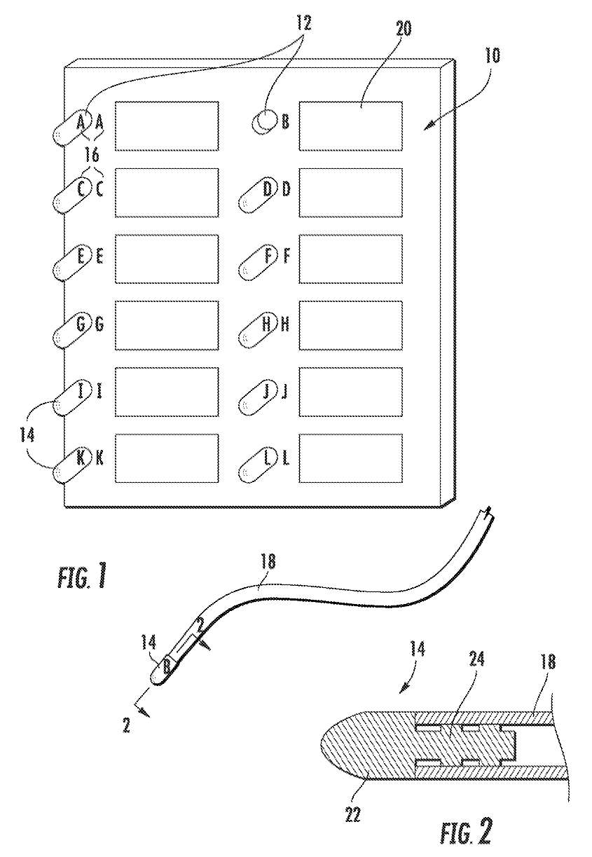

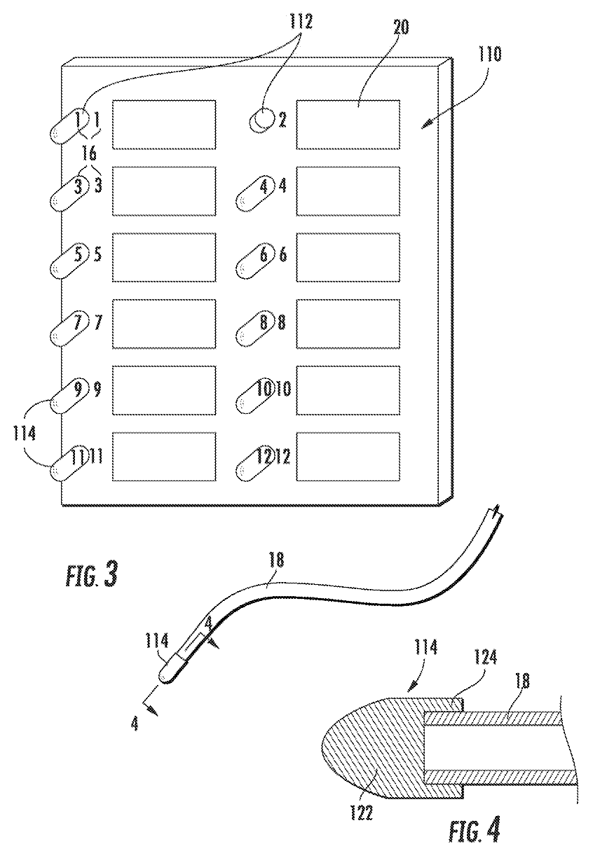

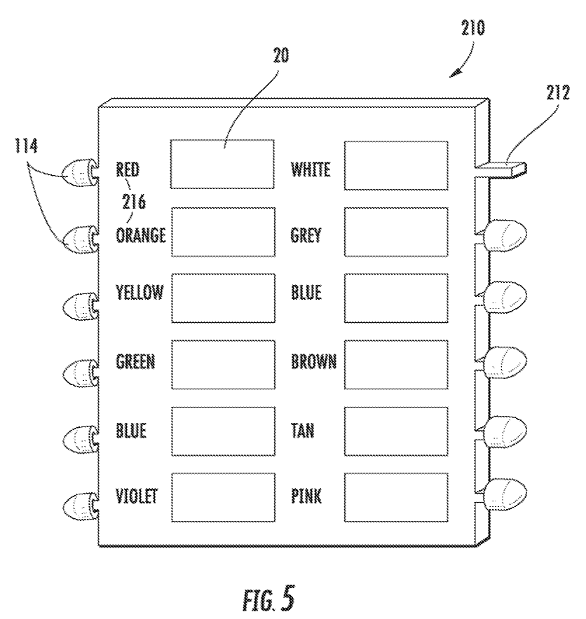

Now referring to the drawings, the system for indexing tubing members in accordance with a first embodiment is shown and generally illustrated in FIGS. 1 and 2, while a second embodiment is provided in FIGS. 3 and 4, and a third embodiment is depicted at FIG. 5. Turning to FIG. 1, system for indexing tubing members generally includes an indexing card 10 having at least one receiver position 12 thereon and at least one end cap 14 received in the least one receiver position 12. Further, each of the end caps 14 and receiver positions 12 bear a unique identifier 16 that serves to match the end cap 14 to its receiver position 12 on the indexing card 10 facilitating the identification of a tubing member as will be described in more detail below.

Preferably, in the context of the present invention, the indexing card 10 includes a plurality of receiver positions 12 thereon and a corresponding plurality of end caps 14 is removably received within the receiver positions 12 on the indexing card 10. In practice, the plurality of end caps 14 are then employed one at a time by affixing the end cap 14 to a terminal end of a tubing member 18 before the tubing member 18 is installed into a structure as part of a larger system made up of a plurality of tubing members 18. For example, the tubing member 18 may be a polymeric tubing material, such as ethylene propylene diamine (EPDM) rubber, polyvinyl chloride (PVC), polyethylene (PE) or cross-linked polyethylene (PEX) as is typically used in commercial and residential construction for the installation of heating systems and the installation of potable water supply lines that require a plurality of tubing members 18 to function properly. Prior to the installation of each of the continuous runs of tubing members 18 that loop out and back around a building's structure, the end cap 14 is removed from the indexing card 10 and installed onto the leading terminal end of the tubing member 18. The tubing member 18 is then installed into the structure by threading the leading end of the tubing member 18 through a plurality of holes drilled in the structure between the desired service location and the point of origin for the heating system or water service. During the installation process each of the tubing members 18 is installed with their ends left hanging at a termination location where they are later attached to the correct system, be it a zone manifold for a heating system, the cold water supply or the hot water supply. Accordingly, when it is time to connect all of the loose ends of the tubing members 18 the installer can simply refer to the end cap 14 and correlate each end cap 14 with the correct receiver position 12 on the indexing card 10 thereby properly identifying the tubing member 18 in order to insure that they are correctly connected.

As was stated above, the indexing card 10 has a plurality of receiver positions 12 thereon in the form of holes that extend either fully or partially therethrough. The receiver positions 12 are sized and shaped to each receive and retain one of the plurality of end caps 14. The indexing card 10 also includes an identifier tag 16 adjacent each receiver position 12 such that the identifier tags 16 on the indexing card 10 correspond to an identical identifier tag 16 on the end cap 14 that is received in the receiver position 12. The identifier tag 16 is preferably alphanumeric (letters or numbers) but may also be a color code. Further, the identifier tag 16 may be a combination of numbers, letters and/or colors. For example, if the identifier tags 16 are letters as depicted in FIG. 1, A, B, C, . . . then each of the end caps 14 will include corresponding letters thereon. Similarly, if the identifier tags are numbers, 1, 2, 3, . . . then each of the end caps will include the corresponding number thereon and if the identifier tags are colors, red, blue, green, . . . then each of the end caps will include the corresponding color thereon. Finally, the indexing card 10 preferably includes a space adjacent the identifying tag 16 that allows the user to write relevant information corresponding to that particular receiver position 12 in order to assist with identify the tubing member 18 at a later date.

The indexing card 10 may be formed from any suitable material, but is preferably formed from a durable polymer material. The indexing card 10, as was stated above, has a plurality of receiver positions 12 thereon. The receiver positions 12 are shown in the first embodiment as holes extending therethrough but may also be formed as holes that extend only partially into the thickness of the indexing card 10 or as pegs that extend outwardly from the indexing card 10. The particular structure of the receiver positions 12 is not important, only that the receiver positions 12 include formations that are suitable for receiving and retaining the plurality of end caps 14 as will be described in detail below. The indexing card 10 also includes an identifier tag 16 adjacent each receiver position 12.

Turning to FIG. 2, it can be seen that the end caps are formed to have a head portion 22 and a tail portion 24. The head portion 22 has an outer diameter that corresponds to the outer diameter of the tubing member 18 and is preferably tapered or rounded in a manner that allows it to be easily threaded through a building structure as the tubing member 18 is installed. The tail portion 24, in this embodiment, is formed to be slightly larger than the inner diameter of the tubing member 18 so that it can be inserted and frictionally retained in the terminal, open end of the tubing member 18. In this embodiment, the tail portion 24 is received into the inner diameter of the tubing member 18. The end cap 14, once installed into the tubing member 18 serves to identify the tubing member 18 by allowing cross-referencing the identification tag 16 on the end cap 14 with the matching identification tag 16 on the indexing card 10. In addition, the end cap 14 also plugs the open end of the tubing member 18 to prevent entry of contaminants, to prevent the end of the tubing member 18 from being damaged and to prevent the end of the tubing member 18 from snagging on the structure during installation therethrough. It should be appreciated by one skilled in the art that end caps 14 and indexing card 10 will be manufactured to sizes that correspond to each of the typical tubing sizes that are used in such installations. When not in use, the end caps 14 are installed back into the corresponding receiver locations 12 on the indexing card 10.

In operation, a user employing a method in accordance with the present invention is presented with an indexing card 10 having a plurality of receiver positions 12 thereon and a plurality of end caps 14 received in each of the receiver positions 12, wherein each of the receiver positions 12 and end caps 14 include a unique matching identifier 16 associated therewith. The user selects one of the end caps 14 and removes it from the receiver position 12 on the indexing card 10. The user then installs the end cap 14 onto the terminal end of one of the tubing members 18 within a plurality of tubing members. Further, the user may elect to make a notation in the corresponding notation space 20 on the indexing card 10 relative to the tubing member 18 that is being installed, i.e. domestic cold-water 1^{st} floor bath. The tubing member 18 is then installed by fishing it through the building structure. The above process is then repeated for each of the tubing members 18 that need to be installed. Once the tubing members 18 are all installed, the user simply returns to the location where the terminal ends of the tubing members 18 are installed and identifies each tubing member 18 by the end cap 14 installed thereon, removes the end caps 14 as the terminal ends of the tubing members 18 are attached to the correct utility and then returns the end caps 14 to the receiver position 12 on the indexing card 10. It should also be appreciated by one skilled in the art that the end caps 14 may be provided in matching pairs such that one of the matching end caps 14 is installed on each of the ends of the length of the tubing member 18. This allows easy identification of the tubing member 18 from either end and allows each of the ends to be matched up with the indexing card 10.

Turning now to FIGS. 3 and 4, an alternate embodiment of the present invention is shown an illustrated. In this embodiment, the end caps 114 include a head portion 122 and a tail portion 124 that is configured to fit about the outer diameter of the tubing member 18. In this regard, the end cap 114 is installed onto the tubing member 18 such that the terminal end of the tubing member 18 is received into an opening in the tail portion 124 of the end cap 114. To receive and retain the end caps 114, the receiver positions 112 on the indexing card 110 are instead formed as protrusions that extend out from the surface of the indexing card 110 in contrast to the holes that were provided in the earlier embodiment. Further, it can be seen that the identification tags 116 in this particular embodiment are depicted as numbers instead of letters. In all other aspects, this embodiment of the present invention operates as described above.

Finally, FIG. 5 depicts another alternate embodiment indexing card 210 for use in conjunction with the alternate embodiment end caps 114 described above. In this regard, the indexing card 210 includes receiver positions 212 that protrude outwardly from the edge of the indexing card 210. In addition, the identification tags 216 in this embodiment are depicted as colors wherein the corresponding end cap 114 will be colored or bear a color band corresponding to the color designation on the indexing card 210.

It can therefore be seen that the present invention provides a method and system that facilitates the indexing and organization of the individual tubing members of a tubing system as they are installed into a structure. In this regard, the present invention provides a system that facilitates installation of the individual tubing members, protects them from damage, prevents the entry of debris into the tubing while also providing a convenient organizational system. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A system for indexing individual tubing members within a plurality of tubing members as they are installed into a structure, said system comprising:
an indexing card having at least one receiver position thereon; and
at least one end cap received in said at least one receiver position,
wherein said end cap and said receiver position each include a unique identifier thereon, said identifier allowing said end cap to be matched to said receiver position.

2. The system of claim 1, further comprising:
a plurality of end caps received in a corresponding plurality of receiver positions on said indexing card,
wherein each of said plurality of end caps is removed from said plurality of receiver positions and installed onto a terminal end of one of said tubing members within said plurality of tubing members thereby allowing each of said tubing members to be correlated to a receiver position on said indexing card based on the end cap received thereon.

3. The system of claim 2, wherein said end caps include a tail portion configured to be received within an inner diameter of said tubing member.

4. The system of claim 2, wherein said end caps include a tail portion configured to be received about an outer diameter of said tubing member.

5. The system of claim 2, wherein said end caps are installed onto said tubing members before they are installed into said structure.

6. The system of claim 5, wherein said end caps cover said terminal end of said tubing member preventing said terminal end from snagging on said structure and preventing debris from entering said tubing member during installation of said tubing member.

7. The system of claim 1, wherein said end caps include a head portion that is at least partially tapered to facilitate threading said tubing member through said structure.

8. The system of claim 1, wherein said unique identifier is chosen from the group consisting of: numbers, letters, colors, symbols and combinations thereof.

9. The system of claim 1, said indexing card further comprising:
a notation space adjacent each of said plurality of receiver locations said space configured to allow notations to be written, said notations facilitating the identification of the corresponding end cap.

10. A method for indexing individual tubing members within a plurality of tubing members as they are installed into a structure, said method comprising the steps of:
providing an indexing card having a plurality of receiver positions thereon, each of said receiver positions including a unique identifier associated therewith;
providing a plurality of end caps, each of said plurality of end caps received in each of said receiver positions, each of said end caps including thereon the unique identifier corresponding to the receiver position wherein said end cap is received;
removing one of said end caps from said receiver position;
installing said removed end cap onto a terminal end of one of said tubing members within said plurality of tubing members; and
repeating said step of removing and installing said end caps for each of said tubing members within said plurality of tubing members thereby allowing each of said tubing members to be correlated to a receiver position on said indexing card based on the end cap received thereon.

11. The method of claim 10, wherein said end caps include a tail portion configured to be received within an inner diameter of said tubing member.

12. The method of claim 10, wherein said end caps include a tail portion configured to be received about an outer diameter of said tubing member.

13. The method of claim 10, further comprising the step of:
installing said tubing members into said structure after said end caps have been installed onto said tubing members.

14. The method of claim 13, wherein said end caps cover said terminal end of said tubing member preventing said terminal end from snagging on said structure and preventing debris from entering said tubing member during installation of said tubing member.

15. The method of claim 10, wherein said end caps include a head portion that is at least partially tapered to facilitate threading said tubing member through said structure.

16. The method of claim 10, wherein said unique identifier is chosen from the group consisting of: numbers, letters, colors, symbols and combinations thereof.

17. The method of claim 10, said indexing card further comprising:
a notation space adjacent each of said plurality of receiver locations said space configured to allow notations to be written, said notations facilitating the identification of the corresponding end cap.

18. The method of claim 17, further comprising the step of:
writing a notation in said notation space regarding a location within said structure after said step of removing said end cap from said indexing card, said notation assisting in later locating said tubing member within said structure.
